(19) United States
(12) Patent Application Publication
(10) Pub. No.: US 2008/0112127 A1
(43) Pub. Date: May 15, 2008

(54) COOLING SYSTEM WITH ANGLED BLOWER HOUSING AND CENTRIFUGAL, FRUSTO-CONICAL IMPELLER

(76) Inventors: Michael Sean June, Raleigh, NC (US); Billy Warren Mediin, Cary, NC (US); Mark Edward Steinke, Durham, NC (US)

Correspondence Address: IBM CORPORATION (SS/NC);c/o STREETS & STEELE, 13831 NORTHWEST FREEWAY, SUITE 355, HOUSTON, TX, 77040, US

(21) Appl. No.: 11/558,223

(22) Filed: Nov. 9, 2006

(51) Int. Cl. G06F 1/20

(52) U.S. Cl. 361/687

(57) ABSTRACT

An improved cooling system for a computer is disclosed. In one embodiment, the improved cooling system includes an angled blower housing and a frusto-conical, centrifugal impeller. The computer chassis has a chassis air inlet and a chassis air outlet. A blower housing is disposed in the computer chassis. The blower housing has a blower inlet face spaced within 0.512 inches (1.3 cm) from a wall of the computer chassis and facing the wall. A blower air inlet is disposed on the blower inlet face and a blower air outlet is in communication with the chassis air outlet. A centrifugal impeller is rotatably supported in the blower housing about an axis of rotation to move air from the blower air inlet to the blower air outlet. The centrifugal impeller defines a generally frusto-conical profile when rotated about the axis of rotation.

### BACKGROUND OF THE INVENTION

1. Field of the Invention

The present invention relates to cooling systems for computers.

2. Description of the Related Art

Computer systems have electronic components that perform various functions and generate heat as a byproduct of electrical resistance. These heat-generating electronic components are typically disposed within a chassis and a cooling system to cool the electronic components. The cooling system generally includes at least one blower for driving airflow through the chassis across the electronic components. A blower may include a blower housing having a blower air inlet, a blower air outlet, and a fan disposed within the blower housing for moving the air through the blower housing from the blower air inlet to the blower air outlet. The blower housing is typically positioned with the blower air outlet in proximity to a chassis air outlet, so that heated air passing through the blower directly exits the computer chassis.

In many computer configurations, such as most “1U” type server chassis, the blower housing is positioned with the blower air inlet being in close proximity to a wall. Closely positioning the blower and the blower air inlet to the chassis wall may be required due to compact chassis configurations having limited space. One drawback of positioning the blower air inlet close to the chassis wall is that there is little space between the chassis wall and the blower housing for air to pass into the blower air inlet. This positioning impedes the flow of air, limiting the efficiency of the cooling system and increasing noise associated with the blower.

Therefore, there is a need for an improved cooling system for a computer system. In particular, it would be desirable to provide a quieter, more efficient blower characterized by a minimal acoustic signature and minimal airflow impedance. Desirably, the improved blower would not require reconfiguring the computer system or repositioning its electronic components. It would also be desirable for the improved blower to operate in a very small space between adjacent walls above and below the blower.

### SUMMARY OF THE INVENTION

According to one embodiment, a cooling system for a computer is provided. A computer chassis is provided for housing electronic computer components. The computer chassis has a chassis air inlet port and a chassis air outlet port. A blower housing is disposed in the computer chassis. The blower housing has a blower inlet face angled between 5 and 15 degrees with respect to an opposing wall of the computer chassis and spaced within about 0.512 inches (1.3 cm) between the blower inlet face and the opposing wall of the computer chassis. A blower air inlet is disposed on the blower inlet face, and a blower air outlet is in fluid communication with the chassis air outlet. A centrifugal impeller is rotatably supported in the blower housing about an axis of rotation to move air from the blower air inlet to the blower air outlet. The centrifugal impeller defines a generally frusto-conical profile when rotated about the axis of rotation.

According to another embodiment, a blower for a computer system is provided. A blower housing has a blower air inlet and a blower air outlet. A centrifugal impeller is rotatably supported in the blower housing about an axis of rotation for moving air from the blower air inlet to the blower air outlet. The centrifugal impeller defines a generally frusto-conical profile when rotated about the axis of rotation.

### BRIEF DESCRIPTION OF THE DRAWINGS

FIG. 1 is a plan view of a server having a “1U” type chassis along with a conventional cooling system and blower configuration.

FIG. 2 is a side elevation view of the server including the conventional cooling system and blower configuration of FIG. 1.

FIG. 3 is a schematic side view of the conventional centrifugal blower configuration of the type shown in FIG. 2.

FIG. 4 is a schematic side view of one embodiment of a server according to the invention having a blower with an angled blower housing to improve airflow and reduce noise.

FIG. 5 is a schematic side view of another embodiment of a server according to the invention having both an angled blower housing and a frusto-conical, centrifugal impeller to improve airflow and reduce noise.

FIG. 6 is a perspective view of one embodiment of a centrifugal, frusto-conical impeller according to the invention.

FIG. 7 is a perspective view of the impeller disposed in a blower housing.

### DETAILED DESCRIPTION OF PREFERRED EMBODIMENTS

The present invention provides an improved computer cooling system that is quieter and more efficient than a conventional cooling system. One embodiment includes an improved blower having a frusto-conical, centrifugal impeller disposed in an angled blower housing. More specifically, the blower housing has a blower inlet face that is angled with respect to a facing wall of a computer chassis. The angled blower housing and the frusto-conical profile of the centrifugal impeller both contribute to improved airflow and reduced noise. The angle of the blower housing with respect to the wall of the chassis increases the spacing between the blower air inlet and the wall, and reduces the angle at which airflow must bend to enter the blower air inlet, both of which reduce airflow impedance and increase airflow to the blower. The angle of the blower housing also modifies the blower's acoustic signature to reduce noise level. The frusto-conical profile of the impeller compensates for the angle of the housing by directing airflow toward a blower air outlet and reducing or eliminating any angle of incidence between the airflow exiting the blower and the wall of the chassis. This further decreases the airflow impedance of the blower. The angle of the blower housing and the frusto-conical profile of the centrifugal impeller each contribute to an improved airflow rate. Improvements in airflow rate of 3.5% have been observed as a result of angling a blower with a conventional, cylindrical impeller. Further improvements in airflow rate are expected to result from the use of a centrifugal impeller having a frusto-conical profile in combination with an angled blower housing according to the invention.

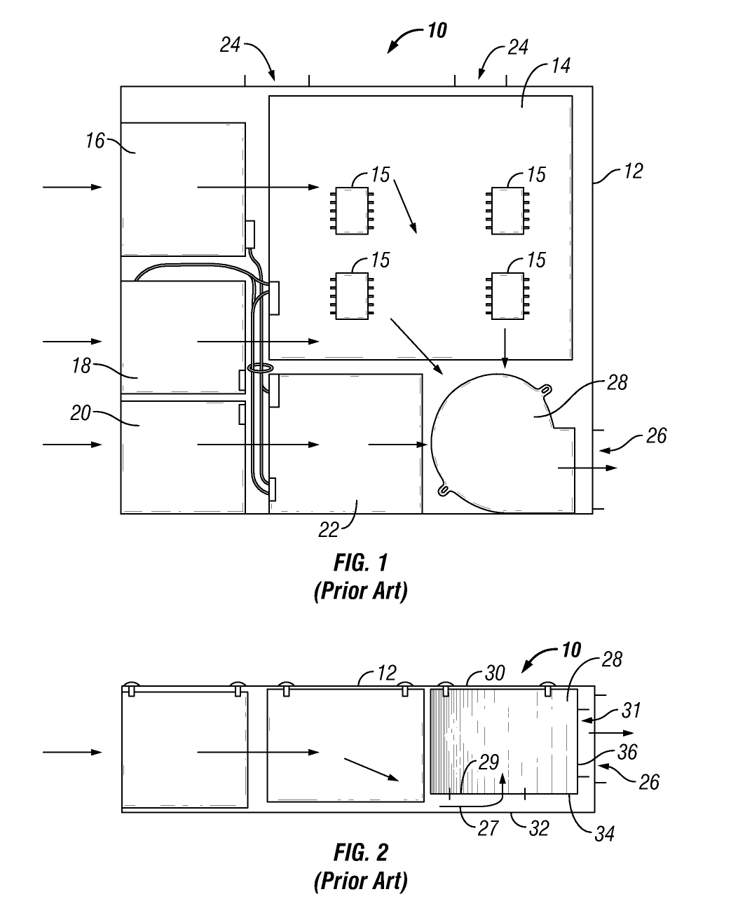

FIG. 1 is a plan view of a server 10 having a “1U” type chassis 12 along with a conventional cooling system and blower configuration. The server 10 may be adapted to include an improved cooling system and blower configuration according to the invention. Multiple heat-generating electronic components are disposed in the chassis 12, including a motherboard 14, a CD bay 16, two removable drives 18, 20, and a power supply 22. The motherboard 14 commonly includes multiple CPUs 15, which may contribute to a substantial portion of the overall heat generated by the server 10. The server 10 is shown with a conventional cooling system that includes two chassis air inlets 24, one chassis air outlet 26, and a blower 28. Other embodiments may include any number of chassis air inlets, chassis air outlets, and blowers. The chassis air inlets 24 are spaced from the chassis air outlet 26 in a manner that provides airflow across the motherboard 14. In this particular embodiment, this airflow is achieved with the chassis air inlets 24 and chassis air outlet 26 on adjacent walls of the chassis 12, though in other embodiments inlet ports and outlet ports may be differently spaced and positioned, such as on opposite ends of a chassis. The blower 28 drives airflow into the chassis 12 through the chassis air inlets 24, over the heat generating components, and exhausts heated air through the chassis air outlet 26, to cool the server 10.

FIG. 2 is a side elevation view of the server 10 including the conventional cooling system and blower configuration of FIG. 1. The blower 28 includes a blower air inlet 29 disposed on a blower inlet face 34 for airflow to enter the blower 28, and a blower air outlet 31 disposed on a blower outlet face 36 for airflow to exit the blower 28. The blower 28 is secured to a first wall 30 of the chassis 12 such that the blower inlet face 34 is spaced from and facing another wall 30 of the chassis 12. The blower inlet face 34 is substantially parallel to the wall 32 or other structures or components of the server 10. Thus, airflow passes through a space between the wall 32 and the blower 28 and traverses a substantially ninety-degree flow path 27 as it enters the blower air inlet 29.

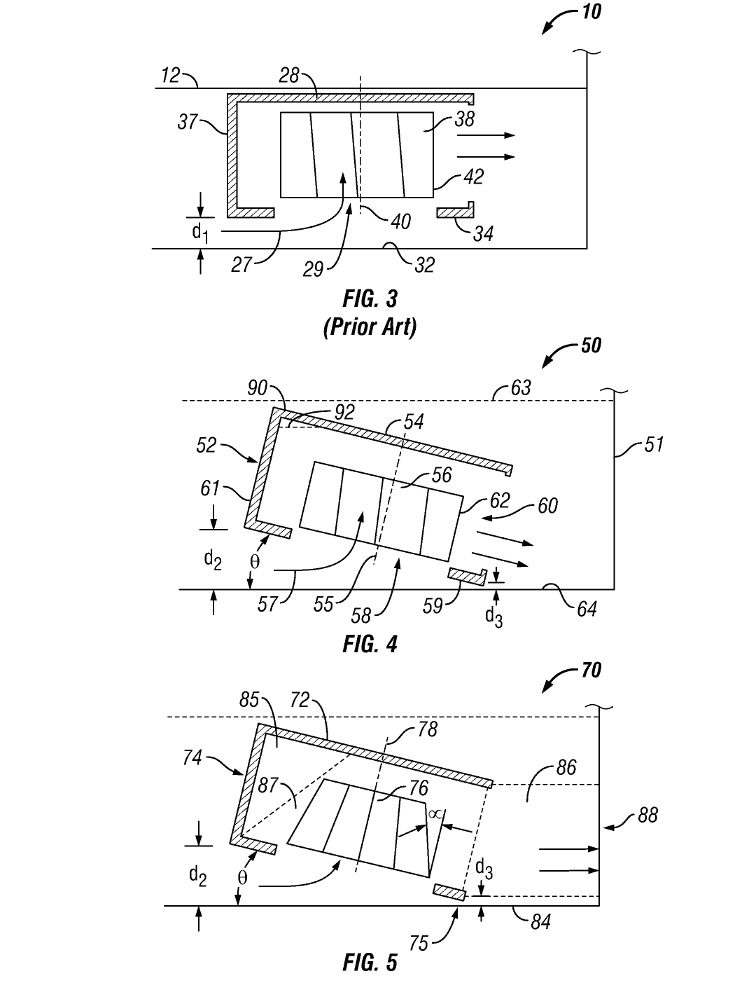

FIG. 3 is a schematic side view of the conventional centrifugal blower configuration of the type shown in FIG. 2. The blower 28 includes a blower housing 37 and a conventional impeller 38 disposed in the blower housing 37. The conventional impeller 38 has a generally cylindrical profile when rotated about its axis 40. The conventional impeller 38 is “centrifugal” in that airflow enters the conventional impeller 38 in a direction substantially aligned with the axis 40 and exits the conventional impeller 38 at a right angle to a cylindrical face 42 defined by the rotating conventional impeller 38. A spacing between the blower inlet face 34 and the wall 32 is labeled “d1,” and is generally uniform along the inlet face 34 due to a generally parallel orientation of the blower inlet face 34 with respect to the wall 32 of the chassis 12. The spacing d1 is typically within about 0.236 inches (0.6 cm). Airflow passes between the blower inlet face 34 and the wall 32 and traverses the substantially ninety-degree bend of the flow path 27 as it enters the blower air inlet 29. The close proximity of the chassis wall 32 and the relatively close spacing d1 provided for airflow to pass between the blower inlet face 34 and the chassis wall 32 increases the airflow impedance and noise level of the blower 28. The airflow impedance and noise levels are further increased due to the generally parallel orientation of the blower inlet face 34 with respect to the wall 32 of the chassis 12 and the corresponding ninety-degree flow path 27 along which airflow is required to travel into the blower 28.

FIG. 4 is a schematic side view of one embodiment of a server 50 according to the invention having a blower 52 with an angled blower housing 54 to improve airflow and reduce noise. An impeller 56 is rotationally supported in the blower housing 54 about an axis 55. The impeller 56 defines a generally cylindrical profile when rotated about the axis 55. The blower housing 54 includes a blower air inlet 58 and a blower air outlet 60. The blower air inlet 58 is disposed on a blower inlet face 59. Although not required, the axis 55 is generally perpendicular to the blower inlet face 59. Though some turbulence may exist within the airflow, and individual airstreams may flow in different directions, a net airflow through the blower 52 enters the impeller 56 in a direction substantially aligned with the axis 55, and exits the impeller 56 at a right angle to a cylindrical face 62 of the cylindrical profile. The blower inlet face 59 is at an angle θ with respect to a wall 64 of a server chassis 51. The angle θ is typically between 5 and 25 degrees, preferably between 5 and 15 degrees, and more preferably between 5 and 10 degrees. A spacing d2 where airflow enters at one end 61 of the blower housing 54 may be as large as about 1 inch (2.54 cm), though d2 is typically no greater than about 0.512 inches (1.3 cm). The spacing d2 is greater than a spacing d3 at an opposite end (i.e., d2>d3) of the blower inlet face 59. The spacing d3 may be essentially zero (i.e., substantially no spacing).

The angling of the blower inlet face 59 desirably reduces noise and airflow impedance of the blower 52. The flow path 57 is less than ninety degrees, which is a more direct flow path through the blower air inlet 58 than the flow path 27 of the conventional blower configuration in FIG. 3. Furthermore, by angling the blower inlet face 59, the spacing d2 may be increased, such that the spacing d2 is greater than the spacing d1 in the conventional blower configuration of FIG. 3 (i.e. d2>d1). This increased spacing further lowers airflow impedance of the blower 52 as compared with the embodiment of FIG. 3.

Angling a blower housing in a server chassis may require modifying the chassis and/or the blower housing, depending on the dimensions of a particular chassis and blower housing. For example, in FIG. 4, the chassis 51 may be modified to increase the distance of a wall 63 from the wall 64 to accommodate the angled position of the blower housing 54 shown. However, it would be desirable to use a blower housing according to the invention in an existing server chassis, to avoid the need to modify the server chassis itself. Thus, rather than modify the server chassis 51, the blower housing 54 may be designed to accommodate its angled position within the chassis 51. For example, the corner 90 could be replaced with the beveled portion 92, which would provide additional clearance for angling the blower housing 54 upward. One skilled in the art and having benefit of this disclosure will recognize other blower housing designs and modifications that fall within the scope of the invention.

The chassis may also be angled about two or more non-parallel axes. For example, the blower housing 54 may be secured in a position that is both tilted on an axis in the plane of the page, and tilted on an axis perpendicular to the page. The blower housing 54 may be secured in its final position to the chassis 51 using conventional fasteners.

Airflow exiting the blower air outlet 60 impinges the wall 64 of the chassis 51 at an angle substantially equal to θ. Though the angled blower housing 54 provides improved airflow, there may still be significant impedance associated with the impingement of the airflow with the wall 64.

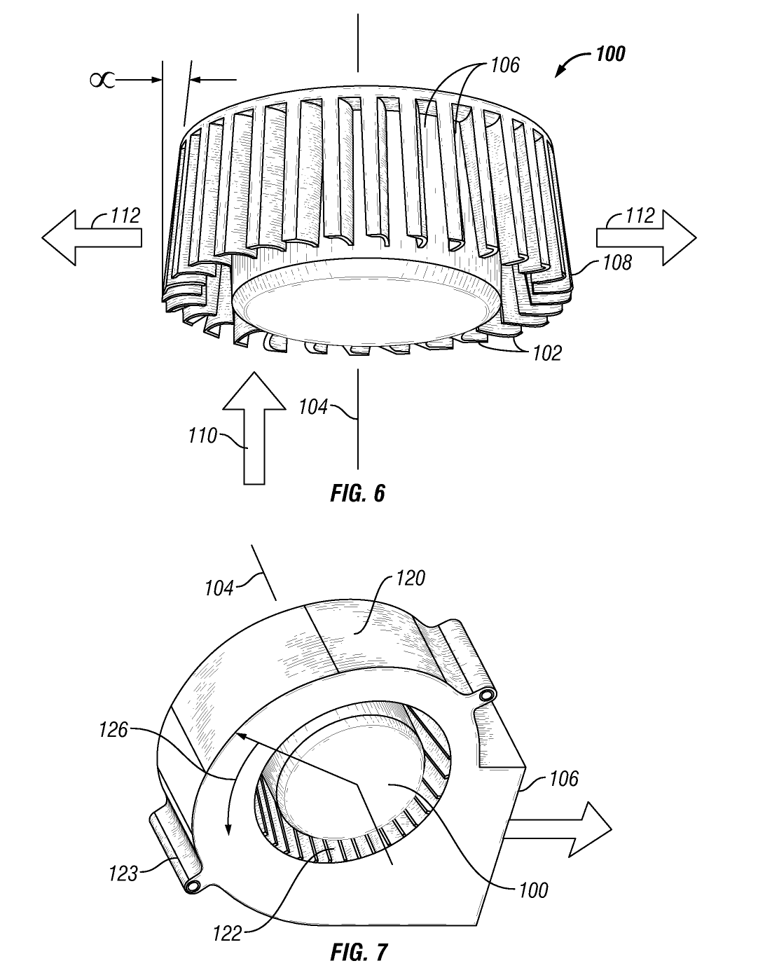

FIG. 5 is a schematic side view of another embodiment of a server 70 according to the invention. The server 70 has an improved cooling system that includes a blower 72 disposed in a chassis 71 of the server 70. The blower 72 has an angled blower housing 74 and a modified impeller 76 that cooperates with the geometry of the angled blower housing 74 to provide an improved airflow through the blower housing 74. More specifically, the impeller 76 defines a generally frusto-conical profile when rotated about its axis 78. Most preferably, the impeller has a sufficient number of blades that the collective outer edge of the blades defines a generally frusto-conical profile even when viewed without rotation. A frusto-conical profile is a frustum created by slicing the top off a cone, with the cut made parallel to the base. In the plane of FIG. 5, a cross-section of the impeller's frusto-conical profile has a generally trapezoidal shape with the top and bottom of the profile perpendicular to the axis 78. The frusto-conical profile has a slant angle α relative to a line parallel to the axis 78, which may be selected to compensate for the angle θ of the blower housing 74. The axis 78 is angled toward a chassis air outlet 88 in a direction away from the wall 84. Although not required, the axis 78 is perpendicular to a blower inlet face 80 on which a blower air inlet 82 is disposed, such that selecting an angle α equal to the angle θ will direct exit airflow parallel to a wall 84 of the server chassis 71. Thus, the frusto-conical profile of the impeller 76 compensates for the angled blower housing 74 to reduce impingement of airflow with the wall 84. The blower housing 74 may be modified to accommodate its angled position, such as by beveling or otherwise reshaping the corner 85 of the blower housing 74. The frusto-conical profile of the impeller 76 desirably provides further clearance between the blower housing 74 and the blade for beveling or reshaping the corner 85.

An optional, but recommended, diverter 86 (indicated by dashed lines) may be included with the blower housing 74 to help channel airflow exiting the blower 72. The diverter 86 may be formed with an upstream portion 87 of the blower housing 74 as a unitary structure, or may be removably attached to the upstream portion 87. The blower housing 74 includes an airflow bend 75 optionally included at or near a junction between the diverter 86 and the upstream portion 87. The recommended diverter 86 helps guide airflow toward the chassis air outlet 88. When the diverter 86 is included, the slant angle α of the frusto-conical impeller profile reduces impingement of airflow with the diverter 86. When the diverter 86 is positioned parallel to the wall 84 as shown, selecting an angle α equal to the angle θ will direct exit airflow in substantial alignment with the orientation of the diverter 86. In other words, the angle α may be selected so that, despite the angling of the blower housing at the angle θ, the impeller profile may be nearly perpendicular to the desired airflow direction.

FIG. 6 is a perspective view of one embodiment of a centrifugal, frusto-conical impeller 100 according to the invention. The impeller 100 includes a plurality of blades 102. The blades 102 are spaced with respect to each other, to provide an airflow path 106 between each blade 102. An outer edge 108 of the blades 102 sweep a generally frusto-conical profile as the impeller 100 is rotated about its axis 104. The impeller 100 is centrifugal in that air gets drawn into the impeller 100 in a generally axial direction 110, and is expelled in a generally radial or transverse direction(s) 112 with respect to the axis 104. If the impeller 100 were rotated without being disposed in a blower housing, airflow would exit the impeller outwardly in all radial directions along a circumference of the impeller. A blower housing is therefore needed to channel and direct the airflow exiting the impeller 100.

FIG. 7 is a perspective view of the impeller 100 disposed in a blower housing 120. A blower air inlet 122 is provided on a blower inlet face 123. The blower air inlet 122 extends circumferentially about the axis 104. As the impeller 100 rotates, airflow enters the blower housing 120 through the blower air inlet 122 and exits the blower housing 120 through a blower air outlet 106. The blower housing 120 therefore channels and directs the airflow exiting the blower air outlet 106. A radius 124 of the blower housing increases in a rotational direction 126 toward the blower air outlet 106.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A cooling system for a computer, comprising:
a computer chassis for housing electronic computer components, the computer chassis having a chassis air inlet and a chassis air outlet;
a blower housing disposed in the computer chassis, the blower housing including a blower inlet face angled between 5 and 25 degrees with respect to an opposing wall of the chassis and spaced within about 1 inch (2.54 cm) between the blower inlet face and the opposing wall of the computer chassis, a blower air inlet disposed on the blower inlet face, and a blower air outlet in fluid communication with the chassis air outlet; and
a centrifugal impeller rotatably supported in the blower housing about an axis of rotation to move air from the blower air inlet to the blower air outlet, the centrifugal impeller defining a generally frusto-conical profile when rotated about the axis of rotation.

2. The cooling system of claim 1, wherein the blower inlet face is angled between 5 and 15 degrees with respect to the opposing wall.

3. The cooling system of claim 2, wherein an angle between the blower inlet face and the wall of the computer chassis is substantially equal to a slant angle of the frusto-conical profile.

4. The cooling system of claim 3, wherein the axis of rotation is substantially perpendicular to the blower inlet face.

5. The cooling system of claim 1, wherein the axis of rotation is angled toward the chassis air outlet in a direction away from the wall of the computer chassis.

6. The cooling system of claim 1, wherein the blower housing further comprises an airflow passage having a bend between the blower air inlet and the blower air outlet.

7. The cooling system of claim 1, further comprising a diverter in fluid communication with the blower air outlet.

8. The cooling system of claim 7, wherein the diverter is substantially parallel with the wall of the chassis.

9. The cooling system of claim 1, wherein the blower inlet face is angled about more than one axis with respect to the chassis.

10. The cooling system of claim 1, wherein the computer chassis comprises a 1U type server chassis.

11. The cooling system of claim 1, wherein the blower inlet face is spaced within about 0.512 inches (1.3 cm) from the opposing wall of the computer chassis.

12. A blower for a computer system, comprising:
a blower housing having a blower inlet face, a blower air inlet disposed on the blower inlet face, and a blower air outlet;
a centrifugal impeller rotatably supported in the blower housing about an axis of rotation for moving air from the blower air inlet to the blower air outlet, and
wherein the centrifugal impeller defines a generally frusto-conical profile when rotated about the axis of rotation.

13. The blower of claim 12, further comprising an airflow passage having a bend between the blower air inlet and the blower air outlet.

14. The blower of claim 12, further comprising a diverter in fluid communication with the blower air outlet.

15. The blower of claim 12, wherein the blower housing is configured for use in a 1U type server chassis to move air from a chassis air inlet to a chassis air outlet.

16. The blower of claim 12, wherein the blower housing is positioned in a computer chassis with the blower inlet face angled between 5 and 15 degrees with respect to a chassis wall and spaced within about 0.512 inches (1.3 cm) from the chassis wall.
